(19) United States
(12) Patent Application Publication
(10) Pub. No.: US 2020/0013030 A1
(43) Pub. Date: Jan. 9, 2020

(54) Systems and Methods for Fraud Reduction

(71) Applicant: JIDOKA PAYMENT SOLUTIONS, Lachish (IL)

(72) Inventor: Zahi Itzhak SHNEIDER, Lachish (IL)

(21) Appl. No.: 16/470,254

(22) PCT Filed: Dec. 25, 2017
(86) PCT No.: PCT/IB2017/058393

§ 371 Date: Jun. 17, 2019

Related U.S. Application Data
(60) Provisional application No. 62/441,394, filed on Jan. 1, 2017.
(60) Provisional application No. 62/530,303, filed on Jul. 10, 2017.

(51) Int. Cl. G06Q 20/10; G06Q 30/02

(52) U.S. Cl. CPC G06Q 20/10; G06Q 30/0283

(57) ABSTRACT

A method comprising: (a) receiving, at a server, a fueling request for a specific vehicle including location data and fuel consumption data; (b) calculating a fueling transaction price based on said consumption data; and (c) transmitting a transaction request for said fueling transaction price to a payment processor and/or a credit provider.

### RELATED APPLICATIONS

This application is a national stage application under 35 U.S.C. § 371 of PCT/IB2017/058393 filed on 25 Dec. 2017 and subsequently published as WO/2018/122723 on Jul. 5, 2018, said PCT application claiming the benefit under 35 U.S.C. § 119(e) of provisional application U.S. 62/441,394 filed Jan. 1, 2017 and having the same inventor as the present application; and

said PCT application also claiming the benefit under 35 U.S.C. § 119(e) of provisional application U.S. 62/530,303 filed Jul. 10, 2017 and having the same inventor as the present application;

each of which is fully incorporated herein by reference.

### FIELD OF THE INVENTION

The invention is in the field of transaction processing security.

### BACKGROUND OF THE INVENTION

Most households in the western world operate at least one car. A study from 2008 found that Americans own 2.28 vehicles per household. In 2015 the average household in the UK was operated 1.4 vehicles and in Japan the vehicles per household has been greater than 1 since mid-90s.

Fuel purchases are made primarily by debt or credit card and less than 30% of drivers throughout the world use cash.

Fuel theft from fleets is on average 6.5% of the fleets' fuel budget.

Many companies use trucks and/or cars for deliveries and/or provide employees with vehicles as a part of their compensation package or as part of their jobs. Many company owned vehicles have Automatic Vehicle Identification (AVI) and payment systems to facilitate fuel purchase and/or repairs and/or routine maintenance. AVI often relies on an RF device installed on the vehicle or an RF tag used by the driver.

The rising number of vehicles on the road contributes to congestion at fueling stations, especially at peak hours. Station operators and drivers have a common interest in reducing the amount of time each fueling event requires.

Existing RF identification systems and other fixed hardware based solutions require installation of hardware at the fueling station and usually a fixed identification device on the fueled vehicle.

Systems based on mobile hardware such as RF tag or a coded card do not necessarily require fixed installation but are more susceptible to fraudulent use, loss, theft or duplication.

Many solutions based on fixed hardware identification require the fueling station to bear the capital and operational cost of installing and maintaining the identification systems. Alternatively or additionally, many solutions based on fixed hardware identification require the vehicle owner or fleet operator to bear the cost of installing and maintaining vehicle side hardware.

Mobile hardware identification often has a lower capital cost for the identification device, but individual setup by the service provider of each identification device for each user can impose a logistic cost.

On-Board Diagnostics (OBD) is an automotive term referring to a vehicle's self-diagnostic and reporting capability. OBD systems give 3^{rd} party access to the status of the various vehicle subsystems. The amount of diagnostic information available via OBD has varied widely since its introduction in the early versions of on-board vehicle computers. Early versions of OBD would simply illuminate a malfunction indicator light or “idiot light” if a problem was detected but would not provide any information as to the nature of the problem. Modern OBD implementations use a standardized digital communications port to provide real-time data in addition to a standardized series of Diagnostic Trouble Code(s) (DTCs), which allow one to rapidly identify and remedy malfunctions within the vehicle. In new versions of OBD, not only troubles and problems are monitored but status of several of vehicle's systems as well, such as light, doors and fuel.

Modern OBD are compatible with a technician's computer designated for a specific vehicle and/or with a mobile phone application and/or have connectivity capabilities, like Bluetooth, WIFI or even a built-in modem. Examples of OBD devices for example are Cavern OBDII Connector by Craven Speed, AutomaticPro by AUTOMTIC and Kiwi2 by PLX. Application and OBD software for example are: Express DIY by AutoTap, Torque Pro mobile app, OBD Car Tracker mobile app, OBD Fusion mobile app and Engie mobile app.

Fleet operators sometimes use telematics devices and/or telematics services to monitor vehicles and drivers. In some cases monitoring is of vehicles' and/or drivers' behavior.

“Connected cars” have communication to the internet built into them. Network connection contributes to an ability to supply features such as embedded navigation system, streaming media system, self-monitoring systems and even parking locating applications.

A “missing documents” credit card transaction is credit card transactions where there is no physical card presence, bill to sign or pin code to enter to verify the card ownership. Missing document credit card transactions contribute to the problem of transactions with stolen credit cards numbers.

### SUMMARY OF THE INVENTION

One aspect of some embodiments of the invention relates to systems and methods that employ one or more non-traditional participants (NTP) in the verification procedure for a transaction. According to various exemplary embodiments of the invention the transaction employs a credit card and/or debit card and/or another payment processor (e.g. paypal, ali-pay, apple-pay). For purposes of this specification and the accompanying claims, the term “non-traditional participants” or “NTP” indicates a party that maintains records concerning a large number of payment transactions but is not a “payment processor” in the traditional sense of the term. In some embodiments the NTP receives a an account number (or portion thereof) or other unique identifier (UID) that associates the user (directly or indirectly) to the account number (or portion thereof) and a second number as a query. According to various exemplary embodiments of the invention the second number is a phone number, email address, instant messaging user name (e.g. skype handle) a driver's license number, an ID number, a social security number, a license plate number, a word (e.g. mother's maiden name) or a date and place of last transaction or other UID.

In some embodiments the second number is used for out of band verification during transaction processing.

According to these embodiments the NTP uses the received pair of numbers to search a DB of similar pairs used in previous transactions. In some exemplary embodiments of the invention, the number pairs stored in the DB are protected by coding and/or hashing and/or encryption. Alternatively or additionally, in some embodiments the DB includes info on whether those transactions later proved to be fraudulent. In some exemplary embodiments of the invention, the NTP returns a yes/no answer indicating simply whether the received pair of numbers is in their DB. In other exemplary embodiments of the invention, the NTP returns a numerical score indicating risk associated with the pair of numbers.

According to this aspect, a merchant adds an extra layer of security to a transaction. In some embodiments the merchant sends the pair of numbers to one or more NTPS for verification prior to submitting the transaction to a transaction payment processor for processing. In some exemplary embodiments of the invention, the extra layer of security provided by NTP verification contributes to a reduction in the risk of approved fraudulent transactions (For example, in missing documents transactions).

According to another aspect of some embodiments of the invention a fueling station optimization center uses user location data (e.g. from GPS chips in cars and/or mobile phones) to ascertain who is in a specific fueling station and calculate an average waiting time. If the average waiting time exceeds a threshold value, the optimization center incentivizes at least some patrons to leave the station early. Incentivization schemes include, but are not limited to, allowing patrons to use “full service pumps” at self-service prices, awarding “points” to a user account, or offering a premium voucher (e.g. free coffee with your next fill-up at off peak hours).

According to yet another aspect of some embodiments of the invention, transaction approval for a fueling event is based on location data of the vehicle to be fueled (i.e. the vehicle is determined to be in a specific station) and the measured fuel consumption of the vehicle since the last fueling event. The transaction is approved only for the amount of the fuel that was consumed by the vehicle and no more than can fit into the vehicle's tank. Upon approval, a pump at the specific station where the vehicle is standing is activated with a transaction size limit. According to various exemplary embodiments of the invention the size limit is set in monetary units or fuel volume. Of course the transaction, when it is actually processed, is only for the amount of fuel actually dispensed by the pump.

According to still another aspect of some embodiments of the invention, service records are validated using data from telematics devices installed in vehicles. According to various exemplary embodiments of the invention the service records are submitted by a service provider to a service sponsor. For purposes of this specification and the accompanying claims, the term “service sponsor” includes, but is not limited to an OEM, a warranty service provider, an insurance company and/or a fleet operator. In some exemplary embodiments of the invention, the service records submitted to the service sponsor are analyzed to determine what vehicles were serviced and may document on what dates and times and/or their odometer reading at the time of the service. Queries comprising vehicle identification data (e.g. license plate number), date and time are sent to telematics DBs. In some exemplary embodiments of the invention, the query includes a service location for each vehicle (e.g. service center name and/or location coordinates). Each query elicits a response including vehicle identification data (e.g. license plate number), date, time and location coordinates. The location coordinates are compared to a list of locations of service centers. In other exemplary embodiments of the invention, an odometer reading at the time of the service in a telematics DB is compared to an odometer reading in the service record.

In some exemplary embodiments of the invention, this independent verification of presence of a specific vehicle in a service center at the time of reported service, contributes to a reduction in fraudulent claims from service providers. According to various exemplary embodiments of the invention the service records are submitted periodically (e.g. daily, weekly, monthly or quarterly). In other exemplary embodiments of the invention, an individual query is sent for each vehicle just prior to, or during a service event or just after the service event.

For purposes of this specification and the accompanying claims, the term “card reader” includes. But is not limited to, conventional card readers, RFID card readers and NFC readers.

For purposes of this specification and the accompanying claims, the terms “number”, “unique identifier” or “UID” each independently include any alphanumeric string. Not all “numbers” are Ms. For Example a date of birth is a number that is not a UID.

For purposes of this specification and the accompanying claims, the term “telematics device” is a device which integrates use of telecommunications and informatics devices or systems for application in and with monitoring of an object and the data related to or generated by the object.

For purposes of this specification and the accompanying claims, the term “telematics” indicates the technology of sending, receiving and storing information via telecommunication devices in conjunction with monitoring of the remote objects.

It will be appreciated that the various aspects described above relate to solution of technical problems associated with transaction validation and/or fraud reduction and/or product liability.

Alternatively or additionally, it will be appreciated that the various aspects described above relate to solution of technical problems related to improvement of traffic flow in fueling stations.

In some exemplary embodiments of the invention there is provided a method including: (a) receiving a first number and a second number as inputs at a data processor; (b) transmitting the first number and the second number to one or more non-traditional participants (NTPs) as a digital query; and (c) receiving a verification response from the NTP(s); wherein at least one of the first number and second number comprises a member selected from the group consisting of account information (or a portion thereof), an ID number (or a portion thereof), a phone number (or a portion thereof), an email address and an instant messaging username. In some exemplary embodiments of the invention, the method includes submitting a transaction to a payment processor for processing after receipt of the verification response. Alternatively or additionally, in some embodiments the verification response is a yes or a no. Alternatively or additionally, in some embodiments the verification response is a score indicative of risk. Alternatively or additionally, in some embodiments one of the numbers is a phone number, email address or instant messaging username. Alternatively or additionally, in some embodiments the method includes performing out of band verification.

In some exemplary embodiments of the invention there is provided a point of sale transaction security system including: (a) a card reader; (b) a user interface adapted to elicit entry of a mobile phone number in response to reading of a card by the card reader; (c) a first verification module configured to transmit a card number supplied by the card reader and the mobile phone number to one or more non-traditional participants (NTPs); and (d) a second verification module adapted to perform out of band verification using the mobile phone number in response to a positive verification response from at least one of the one or more NTPs. In some exemplary embodiments of the invention, the system includes a transaction processor configured to submit a transaction to a payment processor upon receipt of approval of the out of band verification. Alternatively or additionally, in some embodiments the system includes a direct channel of communication from the first verification module to the one or more NTPs. Alternatively or additionally, in some embodiments the system includes an indirect channel of communication from the first verification module to the one or more NTPs via an intervening payment verification processor.

In some exemplary embodiments of the invention there is provided a method including: (a) receiving location data pertaining to a plurality of mobile connected devices at a server; (b) registering the location data on a map of fueling stations using a data processor; (c) calculating an average waiting time at a specific station on the map; and (d) incentivizing some owners of some of the mobile connected devices in a specific station to leave prior to completing fueling when the average waiting time exceeds a threshold value. In some exemplary embodiments of the invention, the calculating is based on the number of mobile connected devices presently in the station. Alternatively or additionally, in some embodiments the calculating is based on temporal data. Alternatively or additionally, in some embodiments the incentivizing includes transmission of a message, via a communications network, to a mobile connected device associated with a specific vehicle.

In some exemplary embodiments of the invention there is provided a system including: (a) a traffic monitor receiving location data pertaining to a plurality of mobile connected devices; (b) a database of fueling station locations; (c) a registration module configured to assign each datum of the location data to a specific fueling station in the database; and (d) a traffic control module configured to incentivize some users of the mobile connected devices in a specific station to leave when a waiting time exceeds a threshold value. In some exemplary embodiments of the invention, the system includes a turnover calculator configured to calculate a waiting time at a specific station in the database. Alternatively or additionally, in some embodiments the calculator calculates based on the number of mobile connected devices presently in the station. Alternatively or additionally, in some embodiments the calculator calculates based on temporal data.

In some exemplary embodiments of the invention there is provided a method including: (a) receiving, at a server, a fueling request for a specific vehicle including location data and fuel consumption data; (b) calculating a fueling transaction price based on the consumption data; and (c) transmitting a transaction request for the fueling transaction price to a payment processor and/or a credit provider. In some exemplary embodiments of the invention, the method includes transmitting an activation signal to a pump at a fueling station corresponding to the location data in response to approval of the transaction request from the payment processor and/or a credit provider. Alternatively or additionally, in some embodiments the method includes providing a code for pump activation. Alternatively or additionally, in some embodiments the fueling request includes a pump number. Alternatively or additionally, in some embodiments the activation signal includes a price limit.

In some exemplary embodiments of the invention there is provided a system including: (a) a fueling request receiver configured to receive data transmissions for specific vehicles, each transmission including location data and fuel consumption data; (b) a transaction size calculator, in communication with the receiver, configured to calculate a fueling transaction size based on the consumption data; and (c) a transaction relay module configured to receive the fueling transaction size from the calculator, issue a transaction request for the fueling transaction size to a payment processor and/or a credit provider across a network, and transmit an activation signal to a pump at a fueling station corresponding to the location data in response to approval of the transaction request from the payment processor. In some exemplary embodiments of the invention, the data transmissions include a pump UID. Alternatively or additionally, in some embodiments the activation signal includes a price limit. Alternatively or additionally, in some embodiments the activation signal comprises a one-time code for pump activation.

In some exemplary embodiments of the invention there is provided a computerized method including: (a) receiving a digital service record including a service location for a specific vehicle via a first channel of communication; and (b) receiving digital telematics data for the specific vehicle via a second channel of communication; wherein the digital service record includes at least one of temporal data and an odometer reading. In some exemplary embodiments of the invention, the digital service record includes temporal data indicating a time and date. Alternatively or additionally, in some embodiments the digital service record includes an odometer reading. Alternatively or additionally, in some embodiments the digital service record includes both temporal data and an odometer reading. Alternatively or additionally, in some embodiments the method is performed for a single vehicle just prior to, during, or immediately after a service event. Alternatively or additionally, in some embodiments the method is performed periodically for a group of vehicles. Alternatively or additionally, in some embodiments the service record and the telematics data each independently include an odometer reading for the specific vehicle. Alternatively or additionally, in some embodiments the service record and the telematics device data each independently include service details.

In some exemplary embodiments of the invention there is provided a service validation system including: (a) a request receiver designed and configured to receive service requests including vehicle identification data at least one of temporal data and odometer reading for verification and relay the request to a query generator; (b) the query generator designed and configured to prepare queries defining single vehicle data and a single time/date and relay the queries to one or more telematics DBs; and (c) a verification module adapted to: (i) receive responses from the one or more telematics DBs, each response including the single vehicle data and a location, and (ii) determine, for each response, whether the location corresponds to a location of a service center stored in a database of service center locations. In some exemplary embodiments of the invention, the service request and the response each independently include an odometer reading for each single vehicle. Alternatively or additionally, in some embodiments the service request and the telematics response each independently include service details.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

For purposes of this specification and the accompanying claims, the phrases “adapted to” and “designed and configured to” as used in this specification and the accompanying claims imposes additional structural limitations on a previously recited component.

For purposes of this specification and the accompanying claims, the term “method” refers to manners, means, techniques and procedures for accomplishing a given task including, but not limited to, those manners, means, techniques and procedures either known to, or readily developed from known manners, means, techniques and procedures by practitioners of architecture and/or computer science.

For purposes of this specification and the accompanying claims, the acronym “DB” indicates database.

For purposes of this specification and the accompanying claims, the term “fueling” indicates filling a tank with fuel (e.g. gasoline, diesel, liquid propane or natural gas) and/or changing or charging one or more batteries.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a simplified flow diagram of a method according to some exemplary embodiments of the invention;

FIG. 2 is a schematic representation of a system according to some exemplary embodiments of the invention;

FIG. 3 is a simplified flow diagram of a method according to some exemplary embodiments of the invention;

FIG. 4 is a schematic representation of a system according to some exemplary embodiments of the invention;

FIG. 5 is a simplified flow diagram of a method according to some exemplary embodiments of the invention;

FIG. 6 is a schematic representation of a system according to some exemplary embodiments of the invention;

FIG. 7 is a simplified flow diagram of a method according to some exemplary embodiments of the invention; and

FIG. 8 is a schematic representation of a system according to some exemplary embodiments of the invention.

### DETAILED DESCRIPTION OF EMBODIMENTS

Embodiments of the invention relate to computerized systems and methods for reducing the risk of fraudulent transactions of various types.

Specifically, some embodiments of the invention can be used to reduce the risk of unauthorized payment transactions. Alternatively or additionally, some embodiments of the invention can be used to reduce the risk of fraudulent fuel purchases.

The principles and operation of systems and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Exemplary Card Fraud Reduction Method

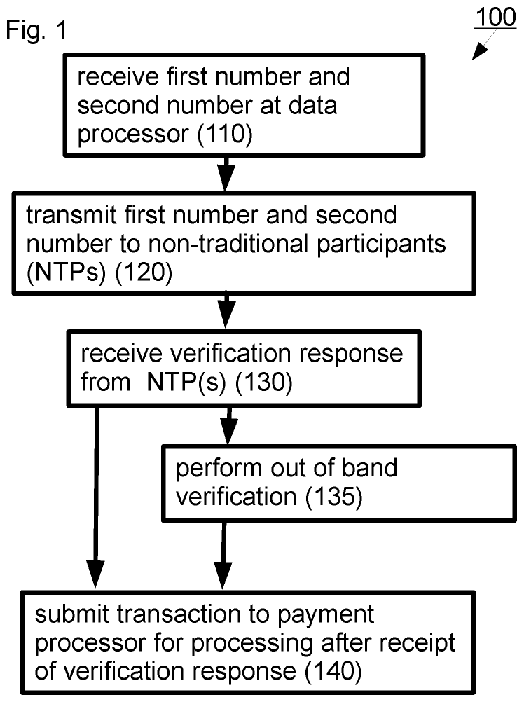

FIG. 1 is a simplified flow diagram of a method for card fraud reduction according to some exemplary embodiments of the invention indicated generally as 100. According to various exemplary embodiments of the invention the card is a credit card, debit card or fueling card.

Depicted exemplary method 100 includes receiving 110 a first number and a second number as inputs at a data processor and transmitting 120 the first number and the second number to one or more non-traditional participants (NTPs) as a digital query. Transmission of the digital query is across a computer network. The term NTP is defined hereinabove in the summary of the invention.

In the depicted embodiment, method 100 includes receiving 130 a verification response from the one or more NTP(s).

According to various exemplary embodiments of the invention at least one of the first number and second number includes a member of the group consisting of account information (e.g. credit card number; debit card number or bank account information), an ID number (e.g. a driver's license number, social security number, passport number or license plate number), a phone number, an email address and an instant messaging username. In some exemplary embodiments of the invention, a portion of a credit card number or account number serves as the first number or second number (e.g. last 4 digits or every other digit of a sixteen digit number).

In some exemplary embodiments of the invention, one of the first number and second number includes account information and the other number includes a phone number or an email address or an instant messaging username.

In some exemplary embodiments of the invention, one of the first number and second number includes an ID number and the other number includes a communication designation (e.g. phone number or an email address or an instant messaging username).

In some exemplary embodiments of the invention, one of the first number and second number includes an ID number and the other number includes account information.

In some exemplary embodiments of the invention, method 100 includes submitting 140 a transaction to a payment processor for processing after receipt of the verification response from the NTP(s).

In some exemplary embodiments of the invention, the verification response received at 130 is a yes or a null. According to these embodiments “yes” indicates that the pair (first number; second number) exists in a DB maintained by the NTP. “Null” indicates that the pair (first number; second number) does not exist in a DB maintained by the NTP. In some embodiments the verification response received at 130 is a yes (e.g. “1”) or a null (e.g. “0”) or a warning code (e.g. “−1”). The warning code indicates that the pair of numbers exists in the DB, but that it is problematic.

In other exemplary embodiments of the invention, the verification response received at 130 is a score indicative of risk. Exemplary scores indicative of risk are described in greater detail hereinbelow.

In some embodiments one of the first number and second number is a phone number, email address or instant messaging username. According to these embodiments, method 100 optionally includes performing 135 out of band verification using the communication designation provided (e.g. phone number, email address or instant messaging username). For purposes of this specification and the accompanying claims, the term “out of band verification” indicates any verification performed via a communication channel other than the channel used for receiving 110.

Exemplary Card Fraud Reduction System

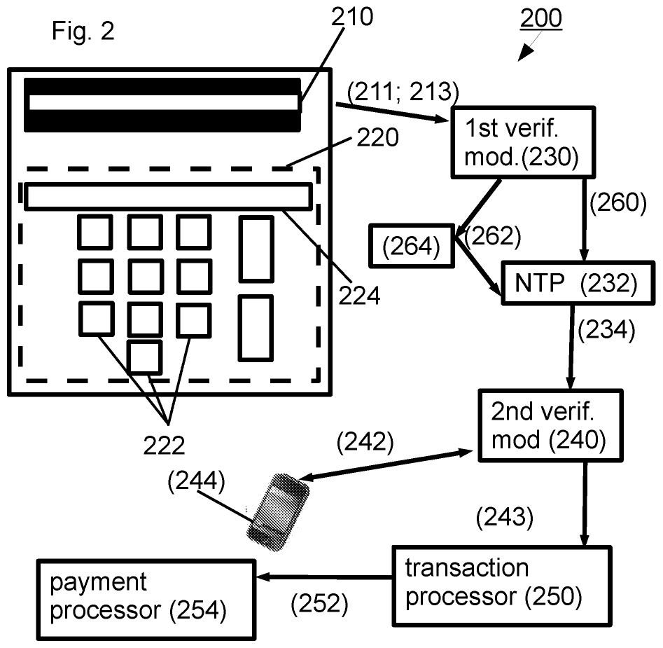

FIG. 2 is a schematic representation of a point of sale transaction security system according to some exemplary embodiments of the invention indicated generally as 200. The various depicted modules and processors each represent computer hardware with firmware or software installed to adapt or configure them to provide the described functions.

Depicted exemplary system 200 includes a card reader 210 and a user interface 220 adapted to elicit entry of a mobile phone number in response to reading of a card by card reader 210. In the depicted embodiment, user interface 220 includes a display screen 224 and a plurality of data entry keys 222. According to the depicted embodiment, reading a card by reader 210 causes a prompt for entry of a mobile phone number to appear on screen 224. The user then enters the phone number using keys 222. In some embodiments there is an “enter” key and in other embodiments the system presumes the number is complete when the correct number of digits has been entered. In the depicted embodiment, user interface 220 is depicted as part of a customer accessible terminal. In other exemplary embodiments of the invention, user interface 220 is operated by sales personnel (e.g. using data entry keys on a cash register). In some embodiments the depicted data entry keys are “virtual keys” on a touch screen. In other exemplary embodiments of the invention, user interface 220 is voice responsive and no keys are present. In voice responsive embodiments of user interface 220 an audio prompt to enter the phone number is optionally provided in addition to, or instead of, the visual prompt on screen 224. In some voice responsive embodiments of user interface 220 screen 224 is not present.

Depicted exemplary system 200 includes a first verification module 230 designed and configured to transmit a card number 211 supplied by card reader 210 and the mobile phone number 213 entered via interface 220 to one or more non-traditional participants (NTPs) 232 and a second verification module 240 adapted to perform out of band verification 242 with a mobile phone 244 using mobile phone number 213 in response to a positive verification response 234 from at least one of NTPs 232.

Depicted exemplary system 200 also includes a transaction processor 250 configured to submit a transaction 252 to a payment processor 254 upon receipt of approval 243 of out of band verification 242 from module 240.

In some embodiments system 200 includes a direct channel of communication 260 from first verification module 230 to NTPs 232.

In some embodiments system 200 includes an indirect channel of communication 262 from first verification module 230 to NTPs 232 via an intervening payment verification processor 264. In some embodiments (not depicted) payment verification processor 264 maintains a duplicate of NTP data and submits verification response 234 to second verification module 240.

Exemplary NTPs

In some exemplary embodiments of the invention, data maintained by NTPs is used to verify a connection between account information and communication information (e.g. phone number, e-mail address or instant messaging user name).

Examples of NTP's that store pairs of numbers including (at least partial) account information in conjunction with communication information include, but are not limited to retail chains (e.g. WALMART), retail shops, health clubs, entertainment venues (e.g. movie theatres), restaurant chains (e.g. PIZZA HUT), utility companies (e.g. electric or phone companies), airlines, municipal governments, public transportation systems, online and/or mobile sales sites (e.g. AMAZON or ALI EXPRESS), mobile app services (e.g. parking app, game app, email app), Health Maintenance Organizations (HMOs), loyalty clubs, accommodation providers (e.g. hotels, hostel, Airbnb), travel companies, service providers (e.g. plumbers, cleaners, gardeners) or Academic or professional schools.

Each of these NTPs is capable of providing transaction validation service by using their existing databases as described hereinabove. Alternatively or additionally, some NTPs may choose to begin collecting data as a way of providing transaction validation service.

Exemplary Scores Indicative of Risk

In some exemplary embodiments of the invention, the validation response supplied by an NTP is a score indicative of risk (see 130 in FIG. 1 and/or 234 in FIG. 2).

In some exemplary embodiments of the invention, the score indicates the number of times that the submitted pair of numbers were associated with a transaction at the NTP. According to these embodiments a score of zero indicates the highest risk and progressively higher scores indicate progressively lower risk.

In some exemplary embodiments of the invention, the score indicates a number of transactions and an average transaction size. Addition of the average transaction size contributes to an ability to detect potentially fraudulent transactions. For example, if a particular pair of numbers shows 75 transactions in the last year with an average size of 86$, and the current transaction is for 9000$, risk may be high for the current transaction.

In some exemplary embodiments of the invention, the score indicates a number of transactions >50$/total number of transactions. This type of score contributes to an ability to identify number pairs associated with an above average (−20$) transaction size. If no problems were previously encountered with transactions using the pair of numbers, the current transaction is probably safe.

In some exemplary embodiments of the invention, the score indicates a time the pair of numbers exist in data base/average transaction size. This type of score contributes to an ability to analyze the current transaction against a longstanding average transaction size. In some embodiments deviations from a long standing pattern indicate risk.

In some exemplary embodiments of the invention, the score indicates the amount of time since the last documented transaction. According to these embodiments a shorter time suggests a higher risk and a longer time suggests a lower risk. The more time passed since last transaction and no fraud claim was made, the safer a transaction is.

In some exemplary embodiments of the invention, the score indicates transaction frequency. For example, 0 indicates no transactions in the last year, 1 indicates at least one transaction in the last year but less than one per month; 2 indicates at least one transaction per month but less than one per week; 3 indicates more than one transaction per week but less than one per day and 4 indicates more than one transaction per day.

In some exemplary embodiments of the invention, the score provides an indication of previous denial and/or check back claims by the payment method owner.

In some exemplary embodiments of the invention, the following scoring system is used for a specific pair of numbers:
(−2) fraud claims or other problems occurred in the past on an account number appearing in the pair;
(−1) account# is suspected or owner was not properly identified;
(0) null response; pair of numbers not found in DB;
(1) pair of numbers found in DB, number of transactions is small;
(2) pair of numbers found in DB, transaction record has a long history without fraud claims or other problems.

It should be noted that a score indicating high risk from a single NTP is not necessarily informative. For example, a query to a single HMO may return a null response because the subject of the query belongs to a different HMO.

Exemplary Method to Reduce Waiting Time at a Fueling Station

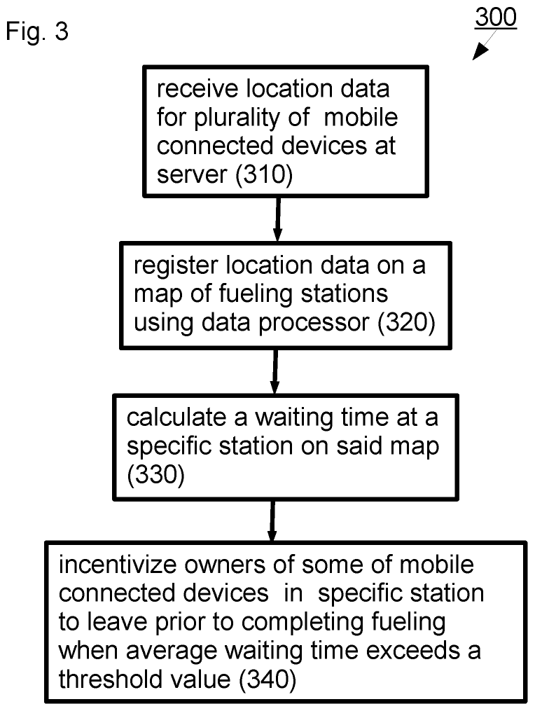

FIG. 3 is a simplified flow diagram of a method to reduce waiting time at a fueling station according to some exemplary embodiments of the invention indicated generally as 300.

Depicted exemplary method 300 includes receiving 310 location data pertaining to a plurality of mobile connected devices at a server and registering 320 the location data on a map of fueling stations using a data processor. In some exemplary embodiments of the invention, location data is supplied by an application running on a mobile phone, telematics device or on a vehicular infotainment system. Registration 320 produces data indicative if the number of mobile connected devices at each station. In some embodiments it is presumed that a single mobile connected device running the relevant application corresponds to a single vehicle.

In some exemplary embodiments of the invention, method 300 includes calculating 330 a waiting time at a specific station on map. According to various exemplary embodiments of the invention the waiting time is calculated an average waiting time and/or median waiting time and/or maximum waiting time and/or minimum waiting time.

In the depicted embodiment, method 300 includes incentivizing 340 some owners of some of the mobile connected devices in a specific station to leave prior to completing fueling when the average waiting time exceeds a threshold value.

In some exemplary embodiments of the invention, calculating 330 is based on the number of mobile connected devices presently in the station. In some embodiments the calculation includes computing (number of connected devices in station)/(number of pumps in station).

In some exemplary embodiments of the invention, calculating 330 is based on temporal data. For example, weekdays have peak times in the morning and early evening when people are en route to and from work. Weekends and holidays have different peak times.

For example, at a specific station location and history are sufficient to predict times/days when there will be a line in the station. In some embodiments such predictions contribute to an ability of the system to take preventive measures to avoid line formation at the predicted time. In some embodiments prediction obviates a need to count vehicles in the station to some degree.

In some exemplary embodiments of the invention, incentivizing 340 includes transmission of a message, via a communications network, to a mobile connected device associated with a specific vehicle. According to various exemplary embodiments of the invention the mobile connected vice includes an infotainment system installed in the vehicle and/or a mobile phone.

Exemplary Method to Reduce Waiting Time at a Fueling Station

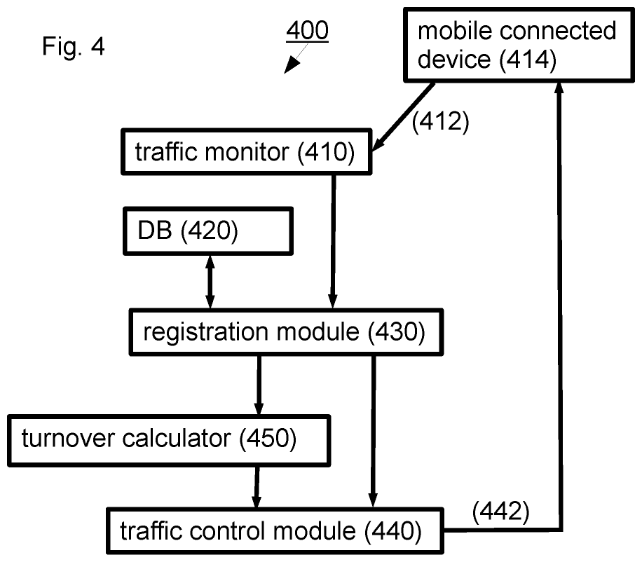

FIG. 4 is a schematic representation of a system to reduce waiting time at a fueling station according to some exemplary embodiments of the invention indicated generally as 400. The various depicted monitors, modules and processors each represent computer hardware with firmware or software installed to adapt or configure them to provide the described functions.

Depicted exemplary method 400 includes a traffic monitor 410 receiving location data 412 pertaining to a plurality of mobile connected devices 414 and a database 420 of fueling station locations.

In the depicted embodiment, system 400 includes a registration module 430 configured to assign each datum of location data 412 to a specific fueling station in database 420.

In some exemplary embodiments of the invention, registration module 430 transmits the registered data to a traffic control module 440 configured to incentivize 530 some users of said mobile connected devices 414 in a specific station to leave the station when a waiting time exceeds a threshold value. According to various exemplary embodiments of the invention patrons are incentivized to finish the fueling process faster and/or leave while the fueling process is still incomplete.

In some exemplary embodiments of the invention, registration module 430 transmits the registered data to a turnover calculator 450 configured to calculate a waiting time at a specific station in database 420. According to various exemplary embodiments of the invention turnover calculator 450 computes a waiting time. Examples of different calculated waiting times are provided hereinabove. In some exemplary embodiments of the invention, calculator 450 computes based on the number of mobile connected devices presently in the station. In some exemplary embodiments of the invention, calculator 450 computes based on historic temporal data. Alternatively or additionally, in some embodiments calculator 450 calculates based on user profiles of specific mobile connected devices 414. For example, some drivers routinely begin fueling, then go to the restroom, and return after fueling is completed. Such drivers increase waiting time more than a simple count would suggest.

In those embodiments of system 400 that include calculator 450, the calculator transmits the waiting tome to traffic control module 440.

Exemplary Incentives

In some exemplary embodiments of the invention, incentivization of users of mobile connected devices in a specific station to leave occurs (see FIG. 3; 340 and/or FIG. 4; 442). In some exemplary embodiments of the invention, incentivization includes transmission of a message, via a communications network, to a mobile connected device associated with a specific vehicle and/or driver or other user.

In some exemplary embodiments of the invention, the response to the incentive depends on the content of the message.

In some exemplary embodiments of the invention, incentives are based on gamification of fueling purchases. For example, (i) a driver receives 10 points per liter for every fueling and the incentive is an offer of 500 points if they leave the station now; or (ii) or the driver receives 1000 points when fueling begins and the number of points is reduced for every time increment that passes until the driver leaves the station. Upon leaving the station, the remaining points are credited to the driver's account.

In some exemplary embodiments of the invention, incentives are based on rewards not associated directly with a fuel purchase. For example, a driver receives a digital coupon on their mobile device redeemable for a free cup of coffee at any convenience store in a fueling station belonging to the same chain within the next 5 days. In some embodiments there is a temporal restriction such as “between 11 AM and 3 PM” or “after 9 PM”.

In some exemplary embodiments of the invention, incentives are based on rewards associated directly with a fuel purchase. For example, a driver receives a digital coupon on their mobile device redeemable with a code that gives the access to full service pumps at self-service prices for a single fueling event. In some embodiments there is a temporal restriction such as “between 11 AM and 3 PM” or “after 9 PM”.

The incentives described here are exemplary, as opposed to limiting.

Exemplary Method to Reduce Fraudulent Fuel Purchases

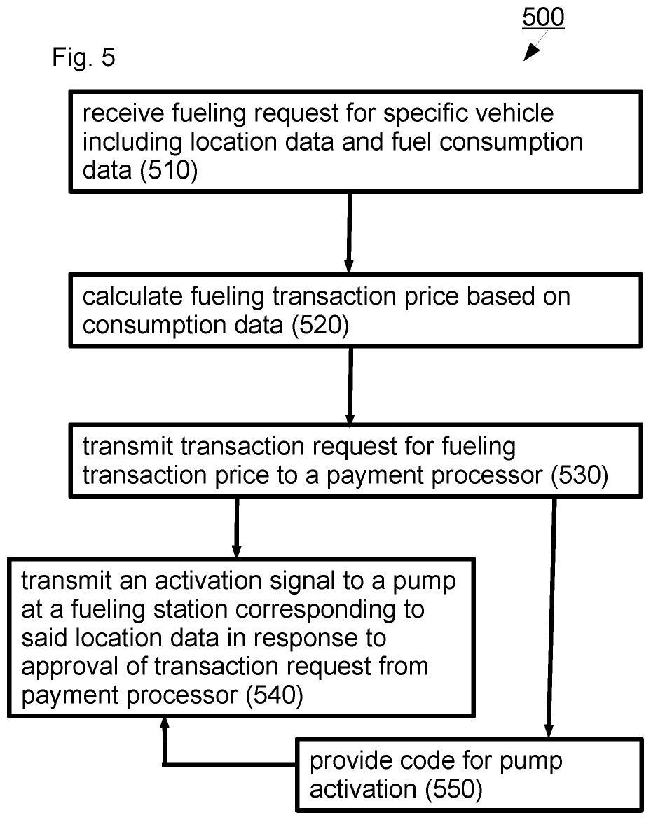

FIG. 5 is a simplified flow diagram of a method reduce fraudulent fuel purchases according to some exemplary embodiments of the invention indicated generally as 500.

Depicted exemplary method 500 includes receiving 510, at a server, a fueling request for a specific vehicle including location data and fuel consumption data, calculating 520 a fueling transaction price based on the consumption data and transmitting 530 a transaction request for the fueling transaction price to a payment processor (e.g. a credit card company or fleet manager).

In some exemplary embodiments of the invention, calculation of fuel consumption data at 510 is triggered by the vehicle approaching a fueling station. If the driver does not purchase fuel, the calculated consumption data is not used. If the driver does purchase fuel, pre-calculation contributes to a reduction in transaction processing time. In some exemplary embodiments of the invention, fueling is only physically enabled (i.e. pump activation 540) when the driver chooses the pump to use and/or enters an activation code (550) and/or lifts the pump handle (nozzle) for fueling.

In some exemplary embodiments of the invention, method 500 includes transmitting 540 an activation signal to a pump at a fueling station corresponding to the location data in response to approval of the transaction request from the payment processor.

In some exemplary embodiments of the invention, method 500 includes providing 550 a code for pump activation. According to various exemplary embodiments of the invention the provided code is a one time code or a user specific code which works only when a specific vehicle is in a specific station.

In some exemplary embodiments of the invention, the fueling request received at 510 includes a pump number. Alternatively or additionally, in some embodiments the activation signal at 540 includes a price limit.

Exemplary Fueling Fraud Prevention System

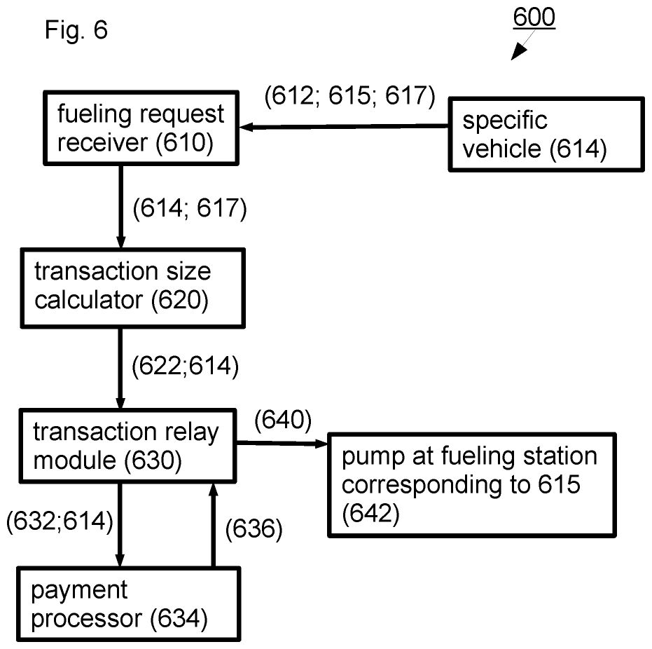

FIG. 6 is a schematic representation of a fueling fraud prevention system according to some exemplary embodiments of the invention. The various depicted receivers, calculators, modules and processors each represent computer hardware with firmware or software installed to adapt or configure them to provide the described functions.

Depicted exemplary system 600 includes a fueling request receiver 610 configured to receive data transmissions 612 for specific vehicles 614. Each transmission 612 includes location data 615 and fuel consumption data 617 in addition to identification of vehicle 614.

In the depicted embodiment, system 600 includes a transaction price calculator 620, in communication with receiver 610. Transaction size calculator 620 calculates a fueling transaction size 622 based on consumption data 617. According to various exemplary embodiments of the invention transaction size is expressed in monetary or volumetric units.

In the depicted embodiment, transaction price calculator 620 transmits transaction price 622 to a transaction relay module 630. Transaction relay module 630 receives fueling transaction price 622 from calculator 620, issues a transaction request 632 for fueling transaction size 622 to a payment processor 634 across a network. Note that payment processor 634 is not necessarily part of system 600, it merely interacts with module 630.

Payment processor 634 returns an approval 636. In some exemplary embodiments of the invention, payment processor 634 is a credit provider. In response to approval 636 transaction relay module 630 transmits an activation signal 640 to a pump 642 at a fueling station corresponding to location data 615. Note that pump 642 is not necessarily part of system 600, it merely receives signal 640 from module 630.

While single arrows are drawn between components for clarity, many embodiments of system 600 rely on hardware components not depicted. For example, in some embodiments pump activation signal 640 is routed through a fuel company gateway to a fuel company server to a station server to a local station controller to controller at an individual pump. In some exemplary embodiments of the invention, actual transaction size (monetary units and/or fuel volume) is reported back to the credit provider and to the vehicle owner.

In some exemplary embodiments of the invention, data transmissions 612 includes a pump UID. For example, in some embodiments a user of a fueling application on a mobile device or vehicle entertainment system receives a prompt, based on location data 615 to select a pump number from a user interface. The application translates the pump number to a pump UID and adds it to data transmission 612.

In some exemplary embodiments of the invention, activation signal 640 includes a price limit. According to these embodiments of the invention transaction relay module 630 incorporates fueling transaction size 622 into activation signal 640. Alternatively or additionally, in some embodiments activation signal 640 includes a code for pump activation. According to these embodiments, a user (driver or station attendant) enters the code to the pump in order to complete the pump activation process. In some exemplary embodiments of the invention, a one-time code is transmitted to a mobile phone belonging to the driver of specific vehicle 614 and entered by the driver (or station attendant) using a keypad on the pump.

Exemplary Service Validation Method

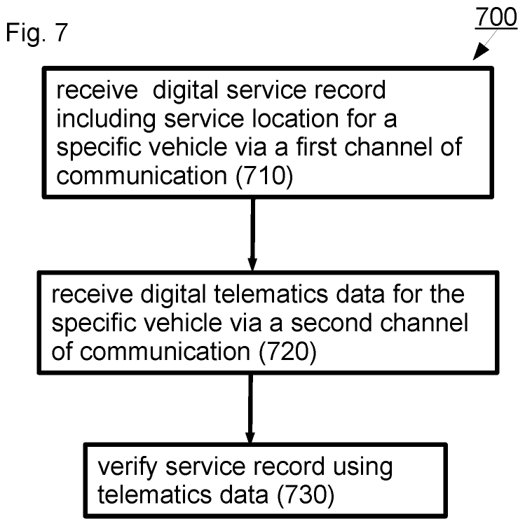

FIG. 7 is a simplified flow diagram of a service validation method according to some exemplary embodiments of the invention identified generally as 700.

Depicted computerized method 700 includes receiving 710 a digital service record including a service location and at least one of a date and time and an odometer reading at the time of the service for a specific vehicle via a first channel of communication and receiving 720 digital telematics data for said specific vehicle via a second channel of communication. In some exemplary embodiments of the invention, the first and second channel of communication are technically similar but temporally displaced from one another.

According to various exemplary embodiments of the invention receiving 710 employs e-mail (e.g. text in body of message and/or attached spread sheet) and/or a DB query (e.g. ACCES or MYSQL) and/or an application program interface (API) for automatic communication between servers and/or an SMS message and/or a fax transmission.

Alternatively or additionally, according to various exemplary embodiments of the invention receiving 720 employs e-mail (e.g. text in body of message and/or attached spread sheet) and/or a DB query (e.g. ACCES or MYSQL) and/or an application program interface (API) for automatic communication between servers and/or an SMS message and/or a fax transmission.

In some exemplary embodiments of the invention, the digital service record includes temporal data indicating a time and date at which service was performed. In some exemplary embodiments of the invention, the digital service record includes an odometer reading. In some exemplary embodiments of the invention, the digital service record includes both the temporal data and the odometer reading.

In some exemplary embodiments of the invention, the digital service record and digital telematics data are stored in computer memories accessible by a single data processor. According to these embodiments, the data processor compares the digital service record to the digital telematics data. This comparison contributes to an ability to ascertain whether the digital service record is valid or potentially fraudulent. If the service record and the telematics data indicate different locations for a vehicle at the time of service or at the odometer reading when service was reported, the service record is likely inaccurate.

In some exemplary embodiments of the invention, method 700 is performed for a single vehicle just prior to, during, or immediately after a service event.

In other exemplary embodiments of the invention, method 700 is performed periodically for a group of vehicles.

In some exemplary embodiments of the invention, the service record and the telematics data each independently include an odometer reading for the specific vehicle.

In some exemplary embodiments of the invention, the service record and the telematics device data each independently include service details. According to these embodiments a car computer in the vehicle relays service records via a telematics device installed in the vehicle.

In the depicted embodiment, method 700 includes verifying 730 the service record using telematics data.

Exemplary Service Validation System

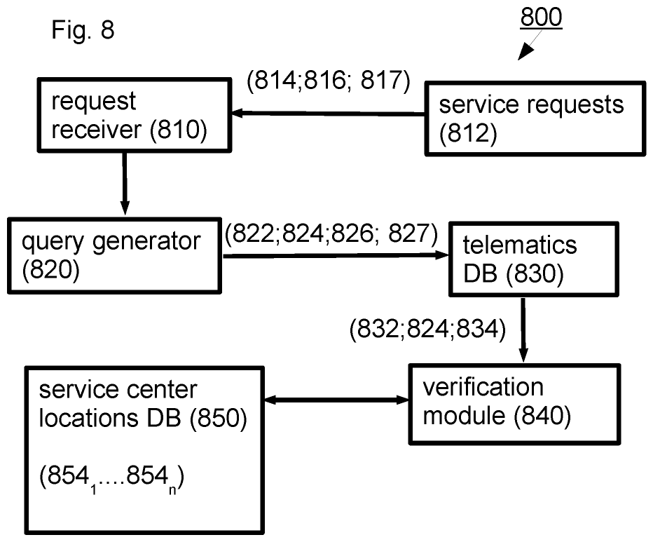

FIG. 8 is a schematic representation of a service validation system according to some exemplary embodiments of the invention. The various depicted components each represent computer hardware with firmware or software installed to adapt or configure them to provide the described functions.

Depicted exemplary system 800 includes a request receiver 810 designed and configured to receive service requests 812 including vehicle identification data 814 and temporal data 816 and/or odometer reading 817 for verification and relay request 812 to a query generator 820.

In the depicted embodiment query generator 820 prepares queries 822 defining single vehicle data 824 and a time/date 826 slot and/or odometer reading 827 and relays queries 822 to one or more telematics DBs 830. Alternatively, in some embodiments request 822 includes only vehicle data 824 and the response would be date of “service reset” from the telematics data

Depicted exemplary system 800 includes a verification module 840 which receives responses 832 from telematics DBs 830. In the depicted embodiment, each response 832 includes single vehicle data 824 and a location 834.

In the depicted embodiment, verification module 840 determines, for each response 832, whether location 834 corresponds to a location 854 of a service center stored in a database 850 of service center locations.

In other exemplary embodiments of the invention (not depicted) response 832 includes single vehicle data 824 and date of last service reset and/or an odometer reading. According to these embodiments verification module 840 determines, for each response 832, whether odometer reading at the time of the service corresponds to odometer reading 817 in request 812 and/or whether “service reset” corresponds to temporal data in request 812.

In some exemplary embodiments of the invention, service request 812 and telematics response 832 each independently include an odometer reading for each single vehicle.

In some exemplary embodiments of the invention, service request 812 and said telematics response 832 each independently include service details. According to these embodiments, a computer in the vehicle relays service records via a telematics device.

System 800 employs channels of communication as described hereinabove for method 700.

Exemplary Service Validation Use Scenario

Referring again to FIGS. 7 and 8, in some embodiments a vehicle service provider submits a service request 812 or report which is received 710 at receiver 810. In some exemplary embodiments of the invention, receiver 810 is operated by an entity that is neither a vehicle service provider nor a telematics service provider.

According to some exemplary embodiments of the invention the request is verified by receiving 720 digital telematics data containing vehicle location 834 at the reported time/date 816. If a vehicle identified 814 in request 812 has a location 834 in DB 830 that matches a service center location 854 stored in service center DB 850 request 812 is verified.

According to some exemplary embodiments of the invention the request is verified by receiving 720 digital telematics data containing vehicle odometer data at the reported time/date 816. If a vehicle identified 814 in request 812 has an odometer reading in DB 830 that matches an odometer reading in request 812, request 812 is verified.

In some exemplary embodiments of the invention, when specific vehicle 814 is in the proximity of a service center location 854 the odometer is automatically documented. This creates a data set including location and odometer reading. When service request 812 is received at receiver 810 it is compared with the data set. A discrepancy between service request 812 and the data set indicates potential fraud.

In some exemplary embodiments of the invention service request 812 including the time/date of service is compared to the vehicle location 834 at the same time received from telematics DB 830. Discrepancies in location at the same time indicate potential fraud.

In some exemplary embodiments of the invention service request 812 including the odometer reading 817 at the time of the service is compared to the vehicle documented location at the same odometer reading in telematics DB 830. Discrepancies in location for the same odometer reading indicates potential fraud.

In some exemplary embodiments of the invention service request 812 is compared with the time, location and/or odometer reading that were documented at a reset of the “service” indicator on the vehicle computer. Discrepancies in location at the same time indicate potential fraud.

It is expected that during the life of this patent many types of card readers, OBDS, car computers and telematics devices will be developed and the scope of the invention includes all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of systems and methods but might also be used in the context of computer program products.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-18. (canceled)

19. A method comprising:
(a) receiving, at a server, a fueling request for a specific vehicle including location data and fuel consumption data;
(b) calculating a fueling transaction price based on said consumption data; and
(c) transmitting a transaction request for said fueling transaction price to a payment processor and/or a credit provider.

20. A method according to claim 19, comprising transmitting an activation signal to a pump at a fueling station corresponding to said location data in response to approval of said transaction request from said payment processor and/or a credit provider.

21. A method according to claim 19, comprising providing a code for pump activation.

22. A method according to any of claim 19, wherein said fueling request includes a pump number.

23. A method according to claim 20, wherein said activation signal includes a price limit.

24. A system comprising:
(a) a fueling request receiver configured to receive data transmissions for specific vehicles, each transmission including location data and fuel consumption data;
(b) a transaction size calculator, in communication with said receiver, configured to calculate a fueling transaction size based on said consumption data; and
(c) a transaction relay module configured to receive said fueling transaction size from said calculator, issue a transaction request for said fueling transaction size to a payment processor and/or a credit provider across a network, and transmit an activation signal to a pump at a fueling station corresponding to said location data in response to approval of said transaction request from said payment processor.

25. A system according to claim 24, wherein said data transmissions include a pump UID.

26. A system according to claim 24, wherein said activation signal includes a price limit.

27. A system according to claim 24, wherein said activation signal comprises a one-time code for pump activation.

28-38. (canceled)

39. A fueling authorization method comprising:
(a) receiving, at a server:
(i) First information representing maximal feasible value;
(ii) Second information representing value at a specific point in time;
(iii) Third information representing last known maximal value in a data set;
(iv) Fourth information representing a first data set indicating value change;
(v) Fifth information representing parameters representing a second data set;
(vi) Sixth information representing increase in value.
(b) Calculating a transaction value based on information (i)-(vi).
(c) Authorizing said calculated transaction value; and
(d) Activating a fuel dispenser with a limitation to said calculated transaction value.
